(19) United States
(12) Patent Application Publication
(10) Pub. No.: US 2019/0101427 A1
(43) Pub. Date: Apr. 4, 2019

(54) SUMP PUMP MONITOR

(71) Applicant: ELEXA CONSUMER PRODUCTS, INC., Bannockburn, IL (US)

(72) Inventors: Lawrence J. BEGER, Lake Forest, IL (US); Michael J. Thariath, Chicago, IL (US); Mateusz CWIOKOWSKI, Palatine, IL (US); Michael Skiba, Chicago, IL (US)

(21) Appl. No.: 16/144,084

(22) Filed: Sep. 27, 2018

Related U.S. Application Data
(60) Provisional application No. 62/565,400, filed on Sep. 29, 2017.

(51) Int. Cl. G01F 23/00; G01F 23/16; G01F 23/18; F04B 51/00

(52) U.S. Cl. CPC G01F 23/0023; G01F 23/161; F04B 23/021; F04B 51/00; G01F 23/18

(57) ABSTRACT

Technology relating to a sump pump monitor is provided herein. A sump pump monitor includes a water level sensor to measure a level of water in a pit of the sump pump, an overflow sensor to detect whether an overflow of the water is present in the pit of the sump pump, and a power monitor to monitor electric power delivered to the sump pump. The power monitor is also to transmit one or more signals indicative of an operational issue associated with the sump pump based on the level of the water, the overflow of the water, and the electric power.

### CROSS-REFERENCE TO RELATED APPLICATIONS

The present application claims the benefit of U.S. Provisional Patent Application No. 62/565,400, filed Sep. 29, 2017, which is incorporated by reference herein.

### BACKGROUND

The present disclosure generally relates to sump pumps, and more specifically, to a sump pump monitor.

Sump pumps are critical to protecting homes and other buildings. Typically, a sump pump may be contained within a sump pump pit of a basement of a home. Water flows into the sump pit either through drains or through the soil. The water may also flow into the pit by flooding or other conditions. The sump pump is to pump the water out of the sump pump pit and away from the building. Doing so may ensure that the basement of the home remains dry. Consequently, a sump pump that is not functioning correctly (e.g., the sump pump is malfunctioning or otherwise not operational) can result in damage to the building.

### SUMMARY

The present disclosure is directed to a sump pump monitor that includes a power monitor, a water level sensor and an overflow sensor. Features and advantages of the disclosure will be set forth in part in the description which follows and the accompanying drawings described below, wherein an embodiment of the disclosure is described and shown, and in part will become apparent upon examination of the following detailed description taken in conjunction with the accompanying drawings.

### BRIEF DESCRIPTION OF THE DRAWINGS

FIG. 1 is a perspective view of a sump pump monitor in accordance with an illustrated embodiment of the present disclosure;

FIG. 2 is a perspective view of a power monitor of the sump pump monitor of FIG. 1;

FIG. 3 is a plan view of a water level sensor of the sump pump monitor of FIG. 1;

FIG. 4 is a perspective view of an overflow sensor of the sump pump monitor of FIG. 1; and

FIG. 5 is a simple block diagram of at least one embodiment of a mobile device configured to receive signals from the sump pump monitor of FIG. 1.

### DETAILED DESCRIPTION

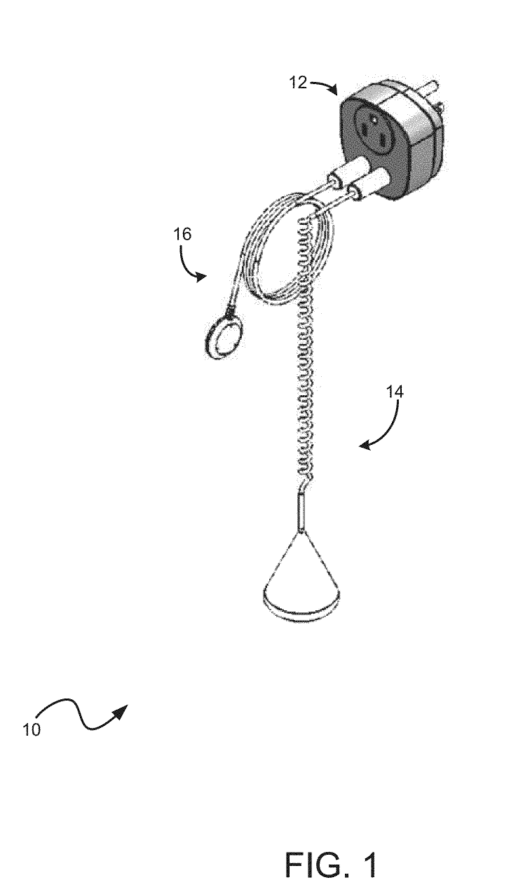

Referring to FIG. 1, a sump pump monitor 10 in accordance with the present disclosure is shown. Illustratively, the sump pump monitor 10 includes a power monitor 12, a water level sensor 14 and an overflow sensor 16. One or more plugs for the water level sensor 14 and overflow sensor 16 may be mechanically reinforced to prevent accidental unplugging. Two examples of such mechanical reinforcements may include: a small plastic hook adjacent to the input(s) on the power monitor unit to act as a strain relief; or using a threaded jack to completely secure the water level and overflow sensor cables to the power monitor 12. Further, the sump pump monitor 10 in accordance with the present disclosure may include a power surge protection device for protecting the sump pump from power surges during operation.

In an embodiment, the sump pump monitor 10 is to observe the performance of a sump pump within a sump pit or the like and report any detected issues to the user electronically such as, for example, via an application (also referred to herein as “app”) executing on a mobile device. As further described herein, the sump pump monitor 10 may monitor properties such as a current draw of electricity, an overflow level of water in the sump pit, a water level in the sump pit, and an electric supply of the sump pump, including additional sump pumps (e.g., backup sump pumps). Doing so allows the sump pump monitor 10 to evaluate the properties against specified thresholds indicative of an issue with the sump pump. More particularly, such issues are indicative of deviations from normal operation of the sump pump, such as an overflow level exceeding a given threshold, issues with a motor in the sump pump, and the like. The evaluation allows the sump pump monitor 10 to detect such issues. Once detected, the sump pump monitor 10 may send one or more predefined signals associated with the detected issue (e.g., the type of issue, measurements relating to the issue, and so on) to the app. In turn, the app may present (e.g., as a push notification on the display of the mobile device) the detected issue and other information associated with the detected issue. Advantageously, doing so allows for a relatively up-to-date notification to a user (e.g., the owner of the sump pump, a technician, etc.).

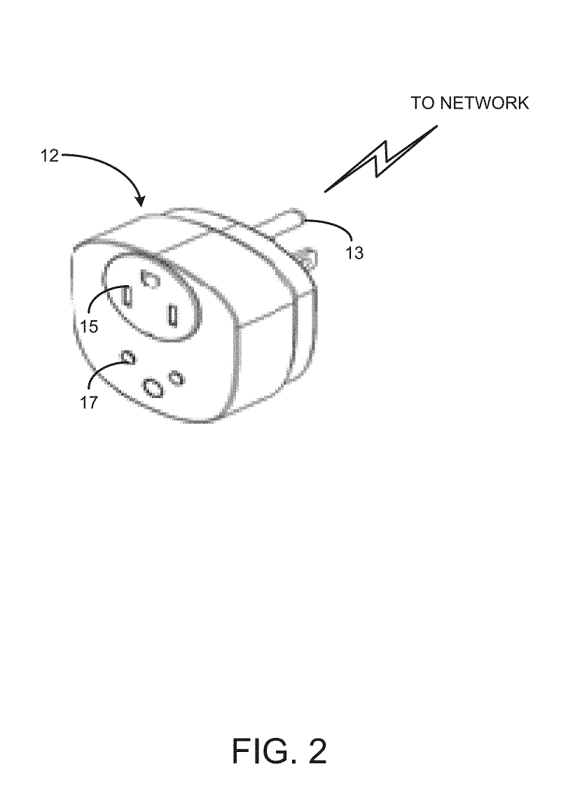

Referring now to FIG. 2, the power monitor 12 of the sump pump monitor 10 is further illustrated. The power monitor 12 is indicative of any apparatus that can deliver power to a sump pump motor. In the illustrative embodiment, the power monitor 12 may plug into any standard power outlet via a plug 13, and includes a power socket 15 to deliver power to the sump pump motor. Electricity passes through the power monitor 12 to a motor of the sump pump. The power monitor 12 is also to continuously measure and record a current draw of electricity to the sump pump motor.

In an embodiment, the power monitor 12 includes network circuitry (not shown) that allows the sump pump monitor 10 to connect to a network and communicate with other devices. For example, the network circuitry may allow the power monitor 12 to establish a connection over a network such as a local area network, the Internet, and the like. The network circuitry may be embodied as any connection that allows the power monitor 12 to establish a wireless connection over the network, such as a Wi-Fi connection, a BLUETOOTH connection, and so on. In some embodiments, the power monitor 12 may be initially configured via the wireless connection by the app. Of course, one of skill in the art will recognize that the power monitor 12 may include circuitry to connect to the network over a wired connection. Once connected, the power monitor 12 may receive and transmit notifications relating to operational issues of the sump pump. For instance, the power monitor 12 may send, to the app over the network, signals when possible malfunctions are detected.

Further, the power monitor 12 may also include an RF antenna and radio (not shown). The RF antenna and radio allows the power monitor 12 to communicate with any RF-capable sensor, such as water detectors. Further still, the power monitor 12 may include a surge protection device for protecting the sump pump from power surges. The sump pump monitor 10 may include a battery backup to perform all functions (except power the sump pump motor) during a power outage.

The power monitor 12 may also have more than one monitored power outputs to provide power to either backup sump pumps or additional sump pumps. Versions of the sump pump monitor 10 with multiple monitored outlets may be used to monitor for various operational issues, including additional issues not explicitly outlined in the present disclosure. In addition, the power monitor 12 provides one or more plug receptacles 17 used to connect with the water level sensor 14 and the overhead monitor 16.

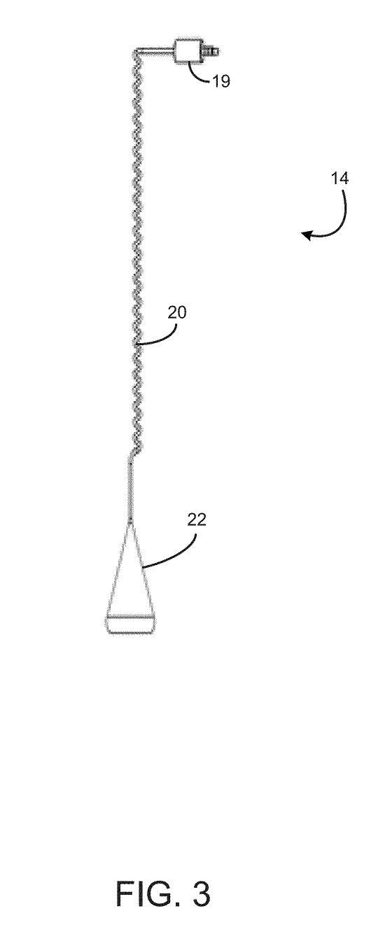

Referring now to FIG. 3, the water level sensor 14 is further shown. The water level sensor 14 connects with the power monitor 12 via a plug 19 into the plug receptacle 17. Further, the water level sensor 14 may hang inside or otherwise extend inside the sump pump. The power monitor 12 may continuously detect and record water level data based on measurements provided by the water level sensor 14. Doing so allows the power monitor 12 to, for example, combine the water level data with power consumption data (e.g., the current draw) to detect whether the sump pump is undergoing an operational issue.

In some embodiments, the water level sensor 14 may include two conductors, each electrically isolated from one another. In some embodiments, the conductors are completely insulated, e.g., from the environment inside a casing. When the two conductors are submerged in water, the capacitance is altered in a measurable and repeatable pattern based on the amount of water in the sump pump pit. The water level sensor 14 uses this phenomenon to monitor the water level in the sump pump—it is two insulated wires, and its effective capacitance is continuously measured and recorded by the circuitry in the power monitor 12.

The water level sensor 14 may further include a coiled cable 20. The coiled cable 20 may be taut to avoid issues caused by slack. Issues relating to slack can cause inconsistencies in the water level readings. Further, slack may also introduce the risk of the water level sensor 14 being sucked into the motor. In addition, the water level sensor 14 may also include a weight 22 at an end of the coiled cable 20 to pull the coiled cable downward. As a result, the weight 22 may allow tension on the coiled cable to be maintained. The connection between the water level sensor 14 and the power monitor 12 may be physically secured at the plug 19 to avoid accidental disconnections. The water level sensor 14 may be extended to any suitable length, such as eight feet.

Further, the water level sensor 14 may measure the increases and decreases in the water level as well of the rates of increase or decrease in the sump pump pit during operation of the sump pump. Such measurements allow the power monitor 12 to detect possible malfunctions (or other operational issues) in the sump pump. For example, if the water level sensor 14 sends measurements indicating that the water level is not decreasing at the calibrated or otherwise expected rate, the power monitor 12 may send a signal that indicates a malfunction of the sump pump.

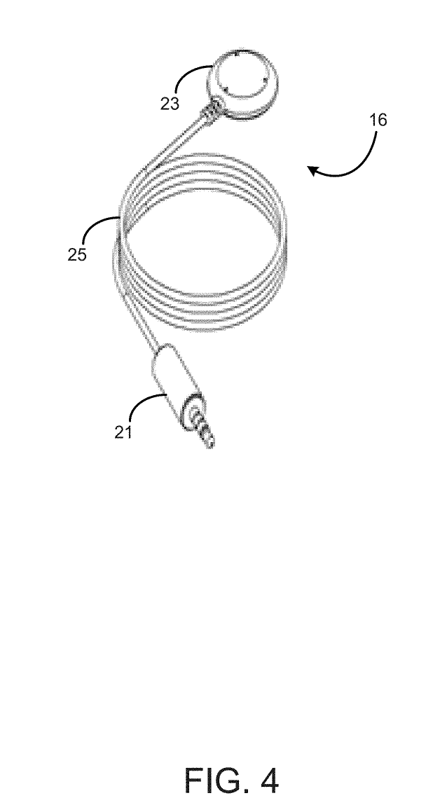

Referring now to FIG. 4, the overflow sensor 16 is further illustrated. The overflow sensor 16 connects with the power monitor 12 via a plug 21 into the plug receptacle 17. In some embodiments, the overflow sensor 16 is a separate unit from the water level sensor 14. Further, the overflow sensor 16 may be integrated into a single cable. A sensor portion 23 in the overflow sensor 16 may be positioned on level with a lip of the sump pump pit or slightly below the lip depending on a water level condition in the sump pump pit.

In some embodiments, the overflow sensor 16 may detect an overflow of water in the event that water makes contact with the sensor portion 23. The overflow sensor 16 may send a notification to the power monitor 12 indicating that the sump pump pit is overflowing. Further, the overflow sensor 16 may also activate a siren alarm thereon. The power monitor 12 may send a notification to the app indicating that the sump pump [it is overflowing. Further, the overflow sensor 16 may include double-sided exposed electrical leads. In the event that water contacts the two leads, the overflow sensor 16 may notify the power monitor 12, and in turn, the power monitor 12 interprets the notification as an overflow event. Thereafter, the power monitor 12 may perform an appropriate action, such as sending a signal to the app and activating the siren alarm.

A wire 25 of the overflow sensor 12 any suitable length, such as eight feet long. The sensor portion 23 may be adjacent to the lip of the sump pump pit, which can be a variable distance from the power monitor 12. Excess length of the wire 25 can be wound around designated wire wrapping clips on the power monitor 12. Doing so may physically secure the connection between the overflow sensor 16 and the power monitor 12 can be physically secure, thus avoiding accidental disconnections.

As stated, the sump pump monitor 10 may monitor various properties. Example properties include a current draw by the sump pump motor at any given time, a water level inside the sump pump pit, an overflow status, and an electricity status. In operation, such properties may vary by time in a predictable manner and further be used to calibrate the sump pump monitor 10 for expected measurements and expected measurement ranges in each property. Once expected measurements and measurement ranges are established, the sump pump monitor 10 can detect variances and notify the user via the smartphone app when measurements in a given property deviates from these expected measurements and ranges (e.g., by a specified threshold for a given property).

For example, the sump pump monitor 10 may detect instances in which the sump pump motor does not turn off. In such an instance, the sump pump pit empties fully, but the sump pump motor does not turn off. As a result, the motor may burn out and cause flooding. To avoid such an instance, the power monitor 12 may detect that a current draw of electricity deviates from an expected range for a given point in time. For example, the power monitor 12 may detect that the current draw remains at a constant amount for a period when the current draw is expected to be at zero. If so detected, the power monitor 12 may send one or more signals to the app indicative of a malfunction in the sump pump motor. The signals may be indicative of information of the malfunction, such as measurements recorded by the power monitor 12, expected measurements, the periods at which the measurements deviated, and the like.

As another example, the sump pump monitor 10 may detect instances in which the sump pump motor does not turn on. In such an instance, the sump pump pit fills up, but the sump pump motor does not activate. Doing so can result in a water level of the sump pump continuing to rise, thus causing flooding within a relatively short amount of time, such as within minutes. To detect such issues, the water level sensor 14 may measure increases in water level that exceed an expected measurement. Further, the power monitor 12 may detect that, concurrently, a measure of the current draw is at zero while the water level is rising. The power monitor 12, upon detecting that the current draw and water level measurements are outside of expected values at the same time, may determine that a malfunction in the sump pump occurred. Once determined, the power monitor 12 may send one or more signals to the app indicative of a malfunction relating to the motor being inactive. For example, the signals may include water level measurements, current draw measurements, expected values for each at given periods, and the like.

As yet another example, the sump pump monitor 10 may detect instances in which the sump pump motor is activated as expected, but the water level continues to increase. In such instances, the sump pump pit fills up and the sump pump motor turns on as expected. However, the water level continues to rise. A rise in water level under these circumstances might result from unusual amounts of groundwater or from a malfunction in the motor. Water levels may continue to rise, thus potentially causing flooding if the issue goes unnoticed. To detect such instances, the water level sensor 14 may detect a rise in water level. Concurrently, the power monitor 12 may detect that measurements for current draw are at a constant positive value during the same period of time in which the water level sensor 14 continues to rise. The power monitor 12, upon detecting that the current draw and water level measurements are outside of expected values at the same time, may determine that a malfunction in the sump pump occurred. Once determined, the power monitor 12 may send one or more signals to the app indicative of a malfunction relating to the water level continuing to increase. For example, the signals may include water level measurements, current draw measurements, expected values for each at given periods, and the like.

Still another example provides that the sump pump monitor 10 detecting instances in which water overflows in the sump pump pit. In this case, the water rises beyond normal limits and overflows the sump pump pit, resulting in an immediate flood. The sump pump monitor 10 may detect such instances based on measurements of current draw, water level, and the overflow level. For example, water may have had contact with the sensor portion 23 of the overflow sensor 16, resulting the in overflow sensor 16 sending a signal to the power monitor 12 indicative of an overflow of the sump pit. Further, the water level sensor 14, during substantially the same time, may detect a continuous rise in water level. Further, the power monitor 12 may detect that the current draw is at a constant positive measurement for the same period of time, which might deviate from expected values, such as for periods of time in which the current draw measurements are expected to be zero. Given these measurements in overflow, water level, and current draw, the power monitor 12 may send one or more signals to the app indicative of a malfunction relating to the overflow in the sump pump pit. For example, the signals may include water level measurements, overflow indications, current draw measurements, expected values for each at given periods, and the like.

As another example, the sump pump monitor 10 may detect instances of electricity failure in the sump pump. In such instances, the sump pump may become inactive. Note, as stated, the power monitor 12 may provide a backup battery for instances of electricity failure. Electricity failure may cause flooding in the sump pump pit. To detect instances, the power monitor 12 may detect that the electric supply provided to the power monitor 10 is zero and that the backup battery is active. Further, the power monitor 12 may also receive measurements of zero for current draw and water level for the same period that the electricity supply has measurements of zero. The power monitor 12, upon detecting that the current draw and water level measurements are outside of expected values at the same time, may determine that an electricity failure occurred. Once determined, the power monitor 12 may send one or more signals to the app indicative of a malfunction relating to the electricity failure. For example, the signals may include electricity measurements, water level measurements, current draw measurements, expected values for each at given periods, and the like.

As yet another example, the sump pump monitor 10 may detect instances of imminent failure in the sump pump motor. In many instances, an aging motor may require increasing amount of current to function. The sump pump monitor 10 may detect the gradual increase in current requirements detect when the behavior of the sump pump is indicative of an imminent failure based on amperage draw. For instance, the power monitor 12 may measure gradually increasing current draw values over time. The power monitor 12 may detect that such increase in values deviate from expected values (e.g., by exceeding a given threshold value or range). Once detected, the power monitor 12 may send one or more signals to the app indicative of a malfunction relating to the imminent failure of the sump pump motor. For example, the signals may include current draw measurements, expected measurements for current draw at given periods, and the like.

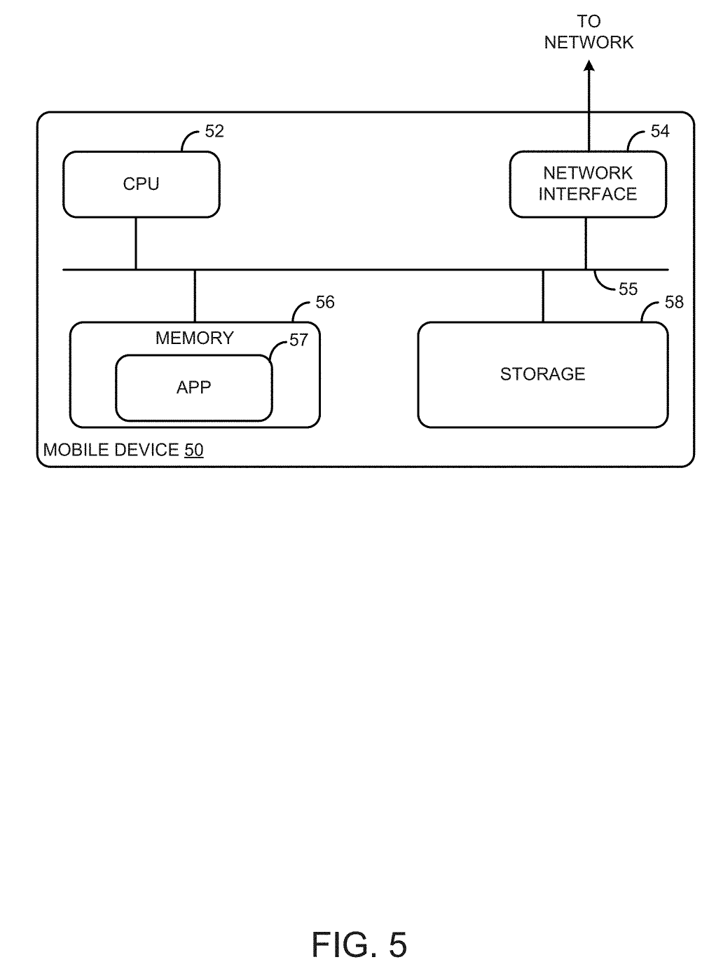

Referring now to FIG. 5, an example mobile device 50 configured to interpret signals from the sump pump monitor 10 and notify a user is shown. As shown, the mobile device 50 includes, without limitation, a central processing unit (CPU) 52, a network interface 54, a memory 56, and a storage 58, each interconnected via a bus 55. Note, these components are shown merely as example components that may be provided with a mobile device 50, and one of skill in the art will recognize that in practice, the mobile device 50 will include additional components and also that in practice that one or more of the components shown need not be provided with the mobile device 50 to be adapted to the embodiments disclosed herein. In an embodiment, the mobile device 50 may be representative of a smartphone device. Other examples can include a tablet device, wearable device, laptop computer, and so on. In an embodiment, the sump pump, the mobile device 50, and the sump pump monitor 10 form a system in which one or more properties associated with the operation of the sump pump are monitored.

The CPU 52 retrieves and executes programming instructions stored in memory 56 as well as stores and retrieves application data residing in the storage 58. The bus 55 is used to transmit programming instructions and data between CPU 52, storage 58, network interface 54, and memory 56. Note, the CPU 52 is included to be representative of a single CPU, multiple CPUs, a single CPU having multiple processing cores, one or more graphics processors, and the like. The memory 56 is generally included to be representative of a random access memory. The storage 58 may be a disk drive storage device. Although shown as a single unit, storage 60 may be a combination of fixed and/or removable storage devices, such as fixed disc drives, removable memory cards, or optical storage, network attached storage (NAS), or a storage area network (SAN).

As shown, the memory 56 includes an app 57. The app 57 is configured to receive one or more signals from the sump pump monitor 10. Once received, the app 57 is also to interpret the signals as an indication of a malfunction or operational issue in the sump pump. For example, the app 57 may interpret given signals relating to measurements in properties such as current draw, water level, overflow level or flag, and electricity level. The app 57 may also interpret signals as issues relating to the properties, such as the motor not activating, imminent failure of the motor, overflow in the sump pump pit, increasing water levels, and the like. The app 57 may present such interpretations as a notification on a display of the mobile device 50. Generally, the app 57 is representative of program code which, when executed on the CPU 52, performs an operation that includes previously described actions.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the disclosure are desired to be protected. The description and figures are intended as illustrations of embodiments of the disclosure, and are not intended to be construed as having or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

We claim:

1. An apparatus comprising:
a water level sensor to measure a level of water in a pit of a sump pump;
an overflow sensor to detect whether an overflow of the water is present in the pit of the sump pump; and
a power monitor to monitor electric power delivered to the sump pump and to transmit one or more signals indicative of an operational issue associated with the sump pump based on at least one of the level of the water, whether the overflow of the water is present, and the electric power.

2. The apparatus of claim 1, wherein the power monitor is further to receive one or more measurements from the water level sensor and the overflow sensor.

3. The apparatus of claim 2, wherein the power monitor is to evaluate the level of the water, the overflow of the water, and the electric power against one or more expected measurements for each of the level of the water, the overflow of the water, and the electric power.

4. The apparatus of claim 1, wherein the operation issue includes at least one of the motor being inoperative, the motor malfunctioning, the water level not decreasing at a predetermined rate, and the water level is overflowing.

5. The apparatus of claim 1, wherein the power monitor is further to deliver electrical power to a motor of the sump pump.

6. The apparatus of claim 1, wherein the water level sensor includes one or more conductors for positioning in the pit of the sump pump to measure capacitance.

7. The apparatus of claim 1, wherein the water level sensor includes (i) one or more insulated wires, (ii) a coiled cable to position within the pit, and (iii) a weight to apply tension to the coiled cable.

8. The apparatus of claim 1, wherein the overflow sensor includes (i) one or more double-sided exposed electrical leads to sense overflow and (ii) a wire.

9. The apparatus of claim 1, wherein the power monitor includes an RF antenna to communicate with an RF-capable sensor, a radio to communicate with the RF-capable sensor, and a battery backup to perform functions during a power outage.

10. The apparatus of claim 1, wherein to transmit the one or more signals indicative of the operational issue associated with the sump pump comprises to transmit the one or more signals to an application executing on a mobile device.

11. A system comprising:
a sump pump;
a mobile device having a processor and a memory, the memory including program code which, when executed, performs an operation; and
a sump pump monitor comprising:
a water level sensor to measure a level of water in a pit of the sump pump,
an overflow sensor to detect whether an overflow of the water is present in the pit of the sump pump, and
a power monitor to monitor electric power delivered to the sump pump and to transmit one or more signals indicative of an operational issue associated with the sump pump based on at least one of the level of the water, whether the overflow is present, and the electric power.

12. The system of claim 11, wherein to transmit the one or more signals indicative of the operational issue associated with the sump pump comprises to transmit the one or more signals to an application executing on a mobile device.

13. The system of claim 12, wherein the operation comprises:
receiving the one or more signals; and
presenting a notification a display of the mobile device indicative of the operational issue associated with the sump pump.

14. The system of claim 11, wherein the power monitor is further to receive one or more measurements from the water level sensor and the overflow sensor.

15. The system of claim 14, wherein the power monitor is to evaluate the level of the water, the overflow of the water, and the electric power against one or more expected measurements for each of the level of the water, the overflow of the water, and the electric power.

16. The system of claim 11, wherein the operation issue includes at least one of the motor being inoperative, the motor malfunctioning, the water level not decreasing at a predetermined rate, and the water level is overflowing.

17. The system of claim 11, wherein the power monitor is further to deliver electrical power to a motor of the sump pump.

18. The system of claim 11, wherein the water level sensor includes one or more conductors for positioning in the pit of the sump pump to measure capacitance.

19. The system of claim 11, wherein the water level sensor includes (i) one or more insulated wires, (ii) a coiled cable to position within the pit, and (iii) a weight to apply tension to the coiled cable, wherein the overflow sensor includes (i) one or more double-sided exposed electrical leads to sense overflow and (ii) a wire, and wherein the power monitor includes (i) an RF antenna to communicate with an RF-capable sensor, (ii) a radio to communicate with the RF-capable sensor, and (iii) a battery backup to perform functions during a power outage.

20. A method, comprising:
measuring a level of water in a pit of a sump pump;
determining whether an overflow of the water is present in the pit of the sump pump;
monitoring electric power delivered to the sump pump; and
transmitting, to a device, one or more signals indicative of an operational issue associated with the sump pump based on at least one of the level of the water, whether the overflow of the water is present, and the electric power.
